(19) United States
(12) Patent Application Publication
(10) Pub. No.: US 2004/0124972 A1
(43) Pub. Date: Jul. 1, 2004

(54) Window anti-pinch and intrusion alarm

(75) Inventor: Anthony Strzelczyk, Farmington Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/330,819

(22) Filed: Dec. 27, 2002

(51) Int. Cl. B60R 25/10

(52) U.S. Cl. 340/426.27; 701/49; 180/271

(57) ABSTRACT

A detection system for use with a motor vehicle automated window control that determines when an obstruction or an intrusion occurs in a gap between the window frame and the window edge. A signal processor controls outputs depending upon the operating condition of the motor. When the motor is driving the window to a closed position, an obstruction inserted in the gap between the window and the frame actuates a motor stop or a motor reversal command to the window motor controller. When the window is stationary, an obstruction in the gap generates a signal at a threshold that enables an alarm siren.

### BACKGROUND OF THE INVENTION

1. Field of the Invention

The present invention relates to an obstruction or intrusion protection system preventing window closure when an obstruction is detected during closure and activating an alarm when an intrusion occurs through an open stationary window.

2. Background Art

Motor vehicles are provided with many convenience options including automatic up window closure systems. Such systems often include protection against pinching obstructions, for example an arm or fingers, that may be introduced to the path of the closing window. Some systems detect the force of or resistance to movement of the window. Other systems often use light emitters and detectors to detect the obstruction by light blockage or reflection at the detector. However, such lighting systems can be extremely sensitive to environmental and traffic lighting conditions whose interference complicates the processing that must occur to determine whether or not an obstruction or a change of environmental lighting has occurred.

The difficulty of determining whether light changes at the detector are due to obstruction or environmental conditions often complicates the types of emitters and detectors used. For example, multiple beams, multiple light paths and multiple detectors for example, segmented detectors, have been employed to improve the ability of the system to discern obstruction type impediments in the light path from ambient light interference. As a result, many of the previously known systems involve highly complex detectors and light paths in the window openings. Moreover, increased complexity in the light paths and deflection substantially affect service life of the systems, particularly in motor vehicles subjected to road hazards, weather conditions and the like.

Moreover, while previously known systems have improved the operation of obstruction sensing during closure of a window, previously known obstruction systems are not well adapted to prevent against intrusion when the window is stationary at an open position. Rather, other types of intrusion alarm systems have been employed in the vehicle in addition to the obstruction detection system and thus further increase the expense and complexity of accessory systems that must be packaged in the vehicle.

### SUMMARY OF THE INVENTION

The present invention overcomes the above mentioned disadvantages by providing a method and apparatus for responding to physical obstruction of a vehicle window opening when the vehicle window is open and moving toward the closed position or in a stationary position. Accordingly, the system provides for detection of intrusion through an open, stationary window and provides protection against pinching obstruction in the window opening when the window is being closed.

In the preferred embodiment, the window pane serves as a light pipe from an emitter to the detector. Preferably, the emitter and detector are located at a lower edge of a window pane so that the light pipe path through the window travels upwardly toward the top of the window frame and is then reflected downwardly toward the detector. The reflection may be enhanced by a reflective coating or seal surface that directs a return path through the light pipe path toward the detector. A displacement of the upper edge of the window pane from the window frame creates a threshold change in the light path, and may be used to signal the condition of the window being open. Of course, another source for detecting an open window condition may trigger the threshold condition. The system provides a response to the threshold condition, for example, the condition activates the light emitter so as to enable the detector to monitor the introduction of an obstruction or an intrusion through the opening.

In the preferred embodiment, when the window is open but stationary, the enabled detector generates an output to the signal processor; that also receives an input that no signal is provided to the window motor controller, and correspondingly switches on a signal to an alarm. The alarm may be a siren or a remote signal transmission to a remote receiver to provide a signal to the vehicle owner. On the other hand, when the signal processor has detected a signal to the window motor controller, for example, during automatic window close operation, the signal processor receives a signal that the window motor controller is operating the window in a closing direction and switches the motor control to provide reverse direction operation of the motor or terminates the actuation of the motor. The signal processor may receive an input from alternating sources derived from the window displacement or operation of the motor to trigger the response that reverses the direction of displacement of the window.

### BRIEF DESCRIPTION OF THE DRAWINGS

The present invention will be more clearly understood by reference to the following detailed description of a preferred embodiment when read in conjunction with the accompanying drawing in which like reference characters refer to like parts throughout the views and in which

FIG. 1 is a diagrammatic view of a motor vehicle employing the protection system of the present invention; and

FIG. 2 is a block diagram of the system incorporated in the vehicle of FIG. 1.

### DETAILED DESCRIPTION OF THE PREFERRED EMBODIMENT

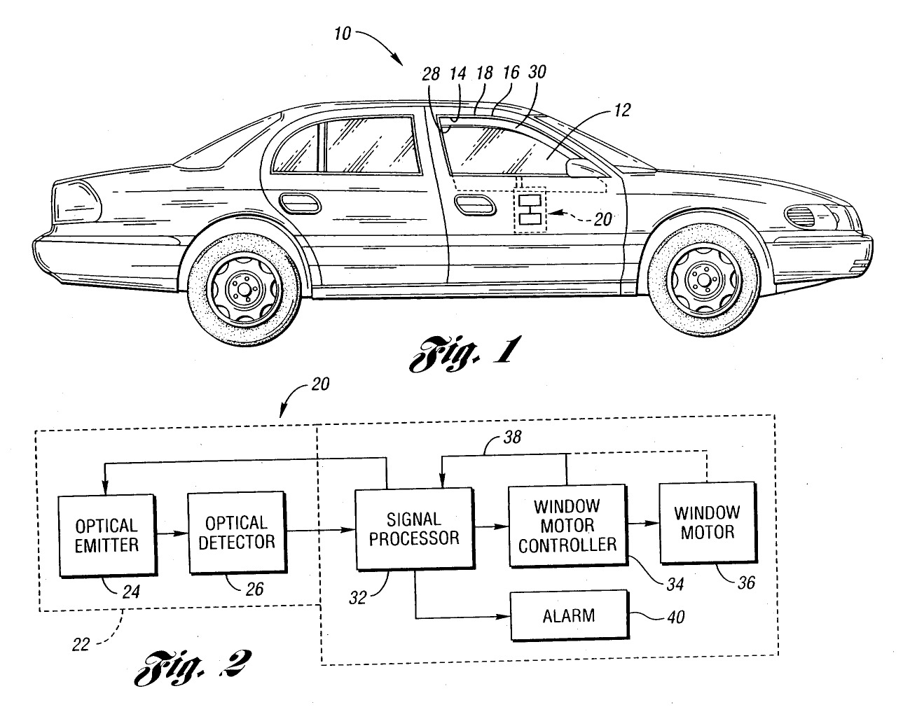

Referring first to FIG. 1, the motor vehicle 10 is shown including at least one, but preferably all, windows including the system 20 for detecting and reacting to an open window 12 displaced from a closed position at which the top edge of the window engages a seal 14 at the window frame 16. Preferably, the seal 14 includes a reflective surface 18, for example, a reflective coating, adjacent the edge of the pane 12. A sensor mechanism 22 preferably packages an optical emitter 24 and an optical detector 26 in a single housing. Preferably, the housing 22 is affixed at the bottom edge of the window pane 12. With the emitter directed at the edge 28 of the window pane so that the window pane forms a light pipe directing light upwardly toward the top edge 28 and reflecting downwards toward the detector 26 when directed by the coating 18. The second branch of the light pipe path extends from the top edge 28 to the detector 26 in the package 22 at the bottom edge of the window 12.

Although many types of emitters are known, infrared emitters and detectors are often selected by as being less affected by ambient light conditions than other ranges of optical emitters, and may be preferred in certain circumstances. The optical detector 26 is preferably the type that distinguishes between small obstructions or intrusions at the upper edge of the window, from large variations due to movement of the window 12 away from the frame 16 or ambient light changes, traffic changes and the like that affect a large portion of the edge. Regardless of whether the emitter 24 uses single or multiple paths to the detector 26, and regardless of the type of detector 26 used, the sensor 22 provides a signal to the signal processor 32 in the vehicle. The processor 32 may be a dedicated signal processor or one used to process a number of functions that may be related to the window operation.

In a preferred embodiment, the emitter 24 is activated when a gap 30 occurs between the upper edge 28 of the window 12 and the frame 16. The signal processor 32 receives a detector output 27 and determines whether the output reaches a threshold. When the threshold value is reacted, the processor enables a response according to the present invention. When the window motor controller 34 is driving the window downward, for example, in response to activation of a Window Down switch, the signal processor 32 need not trigger a response to the output of the detector 26. When the window motor controller 34 has activated the window motor 36 in a direction driving the window to a closed position, a feedback 38 from the controller 34, or alternatively, from the window motor 36 or from the drive mechanism response to motor 36, may be used to signal the processor 32 of the closure direction of window displacement. The feedback 38 enables comparator inputs at the signal processor to establish thresholds that signal an obstruction within the gap 30 as determined by input from the sensor 22. Upon detection of the threshold condition, the signal processor 32 generates a command signal to the window motor controller 34 and may terminate driving of the motor, but preferably, enables a reverse operation of the window motor 36.

The feedback 38 also provides an indication that the window motor controller 34 is not providing a window displacement current to the motor 36. Alternatively, the signal processor 32 may be responsive to other signals, such as the Ignition Off signal, which designate that the window 12 is stationary. Nevertheless, with the other systems in the vehicle deactivated, the sensor 22 may be activated by feedback when the gap 30 appears between the window 12 and the seal 14. Nevertheless, when an obstruction in the gap 30 between the window 12 and the frame 16, is detected by the sensor 22, the output 27 of detector 26 is compared to a threshold representing a non-obstructed condition of a stationary window. Upon detection of a signal level exceeding the threshold, the signal processor 32 enables an alarm for example, an intrusion alarm siren, to be activated.

As a result, the present invention provides an indication that an intrusion occurred even when the window operating system is inactive. As a result, the vehicle may be locked with the window opened for venting, while entry of an arm through the gap 30 enables the system to trigger an alarm when an intrusion has occurred. Moreover, the sensor 22 prevention of an inadvertent pinching of an appendage or other obstruction entering the gap 30 when the motor is displacing the window to its closed position.

Having thus described the present invention, many modifications will become apparent to those skilled in the art to which it pertains without departing from the scope and spirit of the present invention as defined in the claims.

What is claimed is:

1. A process for responding to physical obstruction of a vehicle window opening selectively covered by a motor driven window pane comprising:
positioning light emitter adjacent said window pane;
positioning a detector adjacent to said window pane to define at least one light pipe path through the pane from said emitter when said emitter is illuminated;
detecting the intensity of said at least one light pipe path through said pane, and generating a response signal when said intensity changes at a predetermined threshold;
controlling said window pane from said response signal to reverse the direction of said window pane if said window is closing, and triggering an alarm from said response signal if said pane is stationary.

2. The invention as defined in claim 1 wherein said defining a light pipe path includes reflecting an emitter illumination from a surface adjacent a pane edge.

3. The invention as defined in claim 1 wherein said emitter and said receiver are positioned at a peripheral, bottom edge of said pane.

4. The invention as defined in claim 2 wherein said defining comprises enclosing said pane edge in a door frame seal.

5. The invention as defined in claim 4 wherein said enclosing comprises positioning a reflective surface at said seal.

6. The invention as defined in claim 5 wherein said enclosing comprises coating a seal surface.

7. The invention as defined in claim 4 and activating said emitter when said pane edge is displaced from said seal or said light pipe path is disrupted.

8. An obstruction detection system for a vehicle window with a motor driver pane that closes against a frame edge, the system comprising:
an emitter positioned adjacent said window pane;
a receiver positioned at a pane edge;
a light pipe path through the pane when the emitter is illuminated; and
a processor for comparing when intensity of light detected at said receiver is at a threshold due to displacement from said frame edge in a stationary condition or a threshold due to obstruction during a closing condition.

9. The invention as defined in claim 8 and comprising an activator illuminating said emitter when said light pipe path is disrupted.

10. The invention as defined in claim 8 and comprising a window frame engaging a pane edge opposite to said receiver and an activator illuminating said emitter when said pane edge opposite said receiver is displaced from said window frame.

11. A process for responding to obstruction of a vehicle window opening unless selectively covered by a motor driven pane, comprising:
directing a light pipe path through the pane from an emitter to a receiver positioned at a peripheral edge of said pane, said peripheral edge engaging a frame at a closed position;
detecting the intensity of light transmitted through said light pipe path;
illuminating said emitter when said pane is being displaced toward said frame or is displaced from and stationary at a position separated from said frame; and
comparing said detected intensity and comparing with a first threshold of intensity attributable to displaced position separated from said seal and comparing with a second threshold attributed to disruption of said light pipe path.
